(19) United States
(12) Patent Application Publication
(10) Pub. No.: US 2005/0197962 A1
(43) Pub. Date: Sep. 8, 2005

(54) System and method for multi-channel inbound and outbound communications

(76) Inventors: Steve Taylor Critchfield, Blacksburg, VA (US); Brian Edward Cross, Blacksburg, VA (US); Tony Lee Huffman, Woodstock, GA (US)

Correspondence Address: PILLSBURY WINTHROP SHAW PITTMAN, LLP, P.O. BOX 10500, MCLEAN, VA, 22102, US

(21) Appl. No.: 11/072,418

(22) Filed: Mar. 7, 2005

Related U.S. Application Data
(60) Provisional application No. 60/549,934, filed on Mar. 5, 2004.

(51) Int. Cl. H04K 1/00

(52) U.S. Cl. 705/53

(57) ABSTRACT

The invention provides a centralized, inbound/outbound communications system that enables communication between one or more entities and one or more users via one or more communication channels. In one embodiment, the multi-channel communications system enables the one or more entities to provide one or more government functions to the one or more users. The multi-channel communications system may include a central data repository; an information module that interacts with the one or more entities and provides data regarding the one or more government functions to the central data repository; a presentation module that enables one or more user interfaces; and one or more communication modules that enable the receipt and transmission of data between the common access point and the one or more users in multiple formats across the one or more communication channels.

### RELATED APPLICATION

This application claims priority to U.S. Provisional Patent Application Ser. No. 60/549,934, filed Mar. 5, 2004, which is hereby incorporated herein by reference in its entirety.

### FIELD OF THE INVENTION

The invention relates to a multichannel, inbound/outbound communications system, particularly useful to enable integrated government services systems.

### BACKGROUND OF THE INVENTION

Many local, state, and other public entities have web sites that enable communication with citizens. In many cases, a number of different web sites or systems are used to provide the range of services offered. This leads to various inefficiencies.

One function of government that is particularly important involves notifying citizens in the event of an emergency. In some cases, a government entity may post information to a web site. However, this is not very useful if people do not check the web site. In certain situations it may be necessary or desirable to actually call a group of impacted citizens. This can be very time consuming if done manually.

Another function of government that may be desirable to automate is the paying of bills, the renewal of licenses, and other such administrative interaction between local public entities and the citizenry. In many cases, individual government entities have separate telephonic or web-based points of service. These systems are not standardized and may require the user to interact with multiple systems that contain multiple operating protocols.

Various other drawbacks exist with known systems and methods.

### SUMMARY OF THE INVENTION

The invention solves these and other problems by providing a centralized, inbound/outbound communications system enabling flexible, modular interaction between users and various government entities, quasi-government entities, or other entities over one or more communication channels (referred to herein as a “multi-channel communications system”). For convenience, the invention will be described with regard to “government entities;” however, the invention is not so limited.

In one embodiment, the multi-channel communications system provides an common electronic communications and service “hub,” enabling one or more government functions, quasi-government functions, or other functions. For convenience, the invention will be described with regard to “government functions;” however, the invention is not so limited. In some embodiments, the government functions enabled by the user may be informational government functions, transactional government functions, or other types of government functions.

In some embodiments, the multi-channel communications system may send, receive, and or store data from one or more government entities regarding one or more government functions. The multi-channel communication system may also generate, receive, send, and/or store user-specific data from users that enables, or is related to, one or more government functions.

User-specific data may include: identification, descriptive, and/or demographic data regarding a user; contact information regarding the user; user preference data (including what functions the user desires to use, what information the user desires to receive, how the user wants to receive the information, or other information); or other data. In some embodiments, the system may derive or generate user-specific data such as, for example, usage history information regarding the user based on the user's past interaction with the multi-channel communications system (e.g., past information requests, past information sent to the user, past user transactions, or other historical information). User specific data may be utilized by the multi-channel communication system to provide information to users based on user-selected information broadcasts or system initiated information broadcasts.

The multi-channel communications system may utilize user-specific data to enable one or more government entities to provide one or more government functions to users over one or more of a plurality of communication channels. As such, the one or more government entities participating in the multi-channel communications system may each have access to some or all of a particular user's user-specific data. This common access to user-specific data may enable a plurality of participating government entities to provide information to a user, conduct transactions with a user, or otherwise interact with a user via a common system. This aspect of the invention alleviates problems in the art related to users of government functions having to provide identifying information, contact information, preference information or other information to a variety of separate entities, as well as other problems.

In one embodiment, a multi-channel communications system may include a common communication platform, a plurality of communication modules, an information module, a presentation module, one or more data repositories, a broadcast module, a payment module, a service module, and/or other elements or modules. In one embodiment, the common communication platform may include infrastructure to host and/or support the modules and elements of the invention. The plurality of communication modules may, inter alia, each translate different data formats utilized by different data sources or communication channels utilized by the invention. The information module may, inter alia, receive information from and facilitate transmission of information to the government entities and users of the system. The presentation module may, inter alia, enable one or more user interfaces used by the multi-channel communications system to interact with and/or exchange information with government entities and user of the system. The one or more data repositories may, inter alia, access and/or store government entity information regarding government functions as well as user-specific data. The broadcast module may, inter alia, enable the acceleration of information broadcasts (e.g., alerts) from government entities to one or more users. The payment module may, inter alia, enable the payment of debts, fees or other payments from users to one or more government entities. The service module may, inter alia, provide an automated organization, tracking and routing system for user requests or other government functions provided to specific users of the multi-channel communications system.

In one embodiment, the common communication platform, may include communication and/or information infrastructure (hardware and/or software) supporting the elements and/or modules of the multi-channel communication system. In one embodiment, the common communication platform may host and/or support the plurality of communication modules. The communication modules may provide dynamic data translation and adapter technology, enabling information postings for both inbound and outbound communications to and from both users and/or entities over one or more communication channels. The communication modules may distinguish the types of user devices requesting or receiving services and may provide E-mail broadcast, Call-Out broadcast, Fax Broadcast, TTY broadcast, and other readily available messaging accessories for customized configurations.

In one embodiment, the common communications platform may host and/or support an information module. In one embodiment, the information module may interact with, receive information from, and/or send information to one or more entities. In one embodiment, the information module may integrate with existing infrastructure of entity systems. Entity systems may include any systems of a participating entity, such as, for example, existing entity databases, computers, computer systems, computer networks, or other systems. As different entities may have different types of computer/information systems, one or more communication modules may be utilized to perform any conversions and or adaptations to facilitate fluid information transfer between various entities and the multi-channel communications system. In one embodiment, the information module may also enable inbound and outbound communication between the multi-channel communications system and users via one or more communication channels. The information sent and/or received by the information module may include information enabling government functions to be performed using the multi-channel communications system.

Because the communication channels may utilize different data formats, the information module may utilize the communication modules for data translation as necessary for this communication. The information transmitted via the information module may carry with it process-based functions such as, for example, links to voice response technologies, teletypewriter (TTY) support, faxed documents, online material, customer requests for service and targeted transfers to live staff or separate services. These process based functions may be utilized by communication modules to enable transmission and/or presentation of the different data formats utilized by communication channels.

In one embodiment, the common communications platform may host and/or support the presentation module. The presentation module may utilize web-based or Internet technology, TTY support, telephonic or voice response communications, or any presentation technology necessary enabling one or more user interfaces for visual, auditory, and/or other presentation or reception of data between government entities and users over one or more communication channels.

In one embodiment, the multi-channel communications system may include one or more data repositories. The data repositories may include one or more databases or other data storage devices. The data repositories may store data received from one or more entities, including data enabling or related to government functions. In one embodiment, the data repositories may also store user specific-data received from users, government entities, or generated by the multi-channel communication system that enables or is related to one or more government functions.

In one embodiment, the common communications platform may host and/or support the broadcast module. The broadcast module may enable information dissemination and may work with the information module, the one or more communication modules, and/or other modules or elements of the multi-channel communications system to accelerate information administration and broadcast alerts to users or user devices.

In one embodiment, the common communication platform may host and/or support the payment module. In one embodiment, the payment module may enable a user to simultaneously pay some or all of the amounts owed to one or more government entities participating with the multi-channel communications system. In other embodiments, the payment module may enable a user to separately pay amounts owed to individual entities.

In one embodiment, the common communication platform may host and/or support a service module. The service module may integrate with the information module and/or other elements of the multi-channel communications system to handle service requests or other elements of government functions. For example, the service module may sort through incoming user communications to remove or re-route general user inquiries, and properly log or otherwise handle specific service requests or other requests. The service module may operate on the multi-channel communications system twenty-four hours a day, seven days a week, and thus, may allow service requests to be initiated at any time. Furthermore, service module may associate a tracking identifier (e.g., a tracking number) with individual user requests and provide that tracking identifier to the user, thus, enabling users to access status information regarding particular requests via the multi-channel communications system.

In one embodiment, the multi-channel communications system enables the creation of a multi-department/multi-entity interface or access point, providing more complete and efficient point of service interaction with users. The multi-channel communications system also enables users to sign on, call, or otherwise initiate communications with the multi-channel communications system via one or more of numerous communication channels, and have access to all existing functions, accounts, and/or services provided by or supported by participating entities. The multi-channel communications system also enables the broadcast of information from one or more government entities to one or more users according to user-specific data stored in the system.

Other features, functions, or operations of the invention, including any features, functions, or operations described herein may be enabled by other modules included in the multi-channel communications system according to the invention. In some embodiments, one or more of the modules included in the multi-channel communications system may be combined. For some purposes, not all modules may be necessary.

Those having skill in the art will appreciate that the invention described herein may work with various system configurations. Accordingly, more or less of the aforementioned system components may be used and/or combined in various embodiments. In some embodiments, as would be appreciated, the functionalities described herein may be implemented in various combinations of hardware and/or firmware, in addition to, or instead of, software.

In one embodiment, the invention enables a computer-implemented method for providing one or more government functions of one or more government entities to one or more users using a multi-channel communications system. In one embodiment the multi-channel communications system may include a common communications platform enabling one or more interfaces for performing the one or more government functions over one or more communications channels.

In one embodiment, the multi-channel communications system may receive information regarding one or more government functions from one or more entities. In one embodiment, an information module and/or one or more communication modules may enable receipt of this information. In one embodiment, the information regarding the one or more government functions may be stored in a data repository.

In one embodiment, a communication link between the multi-channel communications system and the at least one user may be established over one or more communication channels. In one embodiment, the multi-channel communications system may utilize user-specific data regarding at least one of the one or more users for whom the one or more government functions are to be performed to establish the communication link. The communication link may be initiated by the user, by the multi-channel communications system, by one of the one or more government entities, or by another party. In some embodiments, the common communication platform or other element of the multi-channel communication system may enable the establishment of the communication link. In some embodiments, the communication link may include a connection enabling data exchange over one or more communication channels. For example, the communication link may include a telephone connection, an Internet or computer network connection, a wireless connection, or other connection.

Once the communication link is established, the user may be presented with some or all of the information regarding the one or more government functions via the one or more interfaces enabled by the common communications platform. In one embodiment, the one or more communications modules or other element of the multi-channel communications system may enable transmission and/or translation of information regarding the one or more government functions.

In one embodiment, the one or more government functions may be performed. In some embodiments the user-specific data of the at least one user may be utilized to perform the one or more government functions. The one or more government functions may include, for example, providing an alert or information to the user, enabling a user to pay debts owed to one or more entities, enabling a user to schedule services provided by the one or more entities, applying for or renewing a license, monitoring the status of a service provided by the one or more entities, or other function (including any functions described herein). Because some governmental, quasi-governmental, or other functions involve the exchange of data between user and one or more entities, data may be provided to the multi-channel communications system by the user over the one or more communications channels. As such, one or more communication modules or other elements of a multi-channel communications system may be utilized to convert data of different formats and/or to provide the data to the communications system and/or the one or more entities.

In some embodiments, a multi-channel communications system according to the invention, and some or all of the various elements features, functions, methods, process, and/or operations described herein may be maintained and/or performed a service provider. In other embodiments, the systems, features, functions, methods, processes, and/or operations may be maintained and/or performed by a participating entity, a group of entities, or other party.

In some embodiments, the centralized nature of the invention avoids disjunctive government services and provides a singular point of service for users, wherein user-specific data may be stored and utilized by numerous government entities for numerous government functions. Furthermore the multi-channel nature of the invention provides a versatile and manageable communications system, that adds to the efficiency and availability of government functions and services.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is a system diagram according to one embodiment of the invention.

FIG. 2 is a system diagram according to one embodiment of the invention.

FIG. 3 is an exemplary process according to one embodiment of the invention.

FIG. 4 is an exemplary login interface according to one embodiment of the invention.

FIG. 5 is an exemplary account home interface according to one embodiment of the invention.

FIG. 6 is an exemplary account information editing interface according to one embodiment of the invention.

FIG. 7 is an exemplary licensing interface according to one embodiment of the invention.

FIG. 8 is an exemplary license information interface according to one embodiment of the invention.

FIG. 9 is an exemplary payment interface according to one embodiment of the invention.

FIG. 10 is an exemplary confirmation interface according to one embodiment of the invention.

FIG. 11 is an exemplary inspection information interface according to one embodiment of the invention.

FIG. 12 is an exemplary service schedule interface according to one embodiment of the invention.

FIG. 13 is an exemplary bill payment interface according to one embodiment of the invention.

FIG. 14 is an exemplary interface according to one embodiment of the invention.

FIG. 15 is an exemplary alert parameter selection interface according to one embodiment of the invention.

FIG. 16 is an exemplary geographic selection interface according to one embodiment of the invention.

### DETAILED DESCRIPTION

In one embodiment, the invention provides a centralized, inbound/outbound communications system enabling flexible, modular interaction between users and various government entities, quasi-government entities, or other entities over one or more communication channels (referred to herein as a “multi-channel communications system”). For convenience, the invention will be described as involving “government entities;” however, the invention is not so limited. Other entities may participate in a multi-channel communications system according to the invention.

In one embodiment, the invention provides functionality to address each aspect of comprehensive eGovemment services by enabling a wide array of governmental, quasi-governmental, or other functions or services through the multi-channel communications system. For convenience, the invention will be described as involving “government functions;” however, the invention is not so limited. Other functions or services may be enabled and/or performed by a multi-channel communications system according to the invention.

In one embodiment, the multi-channel communications system provides a common electronic communications and service “hub,” enabling government entities to interact with users from a single system. In one embodiment, the centralized hub design may enable the creation of a multi-department/multi-entity interface or access point, providing more complete and efficient point of service interaction with users. The common hub aspect of embodiments of the invention enables multiple participating government entities to utilize part or all of a common set of user-specific data, thus improving the efficiency of providing a wide range of government functions. In one embodiment, the hub aspect of the invention also enables users to sign on, call, or otherwise establish communications with the multi-channel communications system via one or more of numerous communication channels, and have access to all existing functions, accounts, and/or services provided by or supported by participating entities via a common communications platform.

In some embodiments, the multi-channel communications system may send, receive, and or store data from one or more government entities regarding one or more government functions. The multi-channel communication system may also generate, receive, and/or store user-specific data from users that enables one or more government functions. The user-specific data may be utilized by numerous government entities and the multi-channel communication system to communicate with and/or provide information or government functions to users based on user-selected parameters, system-generated parameters, or other parameters.

User-specific data may include: identification, descriptive, and/or demographic data regarding a user; contact data regarding the user; user preference data (including what functions the user desires to use, what information the user desires to receive, how the user wants to receive the information, or other information); or other data. For example, the user may provide (or the system may otherwise obtain) the multi-channel communications system with identification descriptive and/or demographic data regarding the user (e.g., name, social security number, address, marital status, occupation, or other information). This data may be used by the multi-channel communications system to identify the user, establish an account for the user, or for other purposes.

In some embodiments, the user may also provide (or the system may otherwise obtain) contact information (e.g., mailing address, email addresses, IP addresses, telephone numbers, fax numbers, and/or other contact information) to the multi-channel communications system. This contact information may enable the multi-channel communications system to identify the user, contact the user, or otherwise communicate with the user for the purpose of providing one or more government services, or for other reasons.

In some embodiments, the user may provide the multi-channel communications system with preference data (e.g., what information or government functions the user whishes to receive, when they want to receive it, how they want to receive it, or other information. This preference data may be used by the multi-channel communication system, to determine the parameters by which the user prefers to interact with the one or more government entities via the multi-channel communications system.

In some embodiments, the multi-channel communications system may derive or generate user-specific data such as, for example, usage history information regarding the user based on the user's past interaction with the multi-channel communications system (e.g., past information requests, past information sent to the user, past user transactions, or other historical information). This and other “system generated” user-specific data may be utilized to provide specific government functions to the user. For example, the past transactions of a user may indicate that the user has held a fishing license for the past few years. The multi-channel communications may utilize this data to broadcast an alert to the user regarding an upcoming community meeting related to fish and wildlife, even though the user did not positively select to receive this alert.

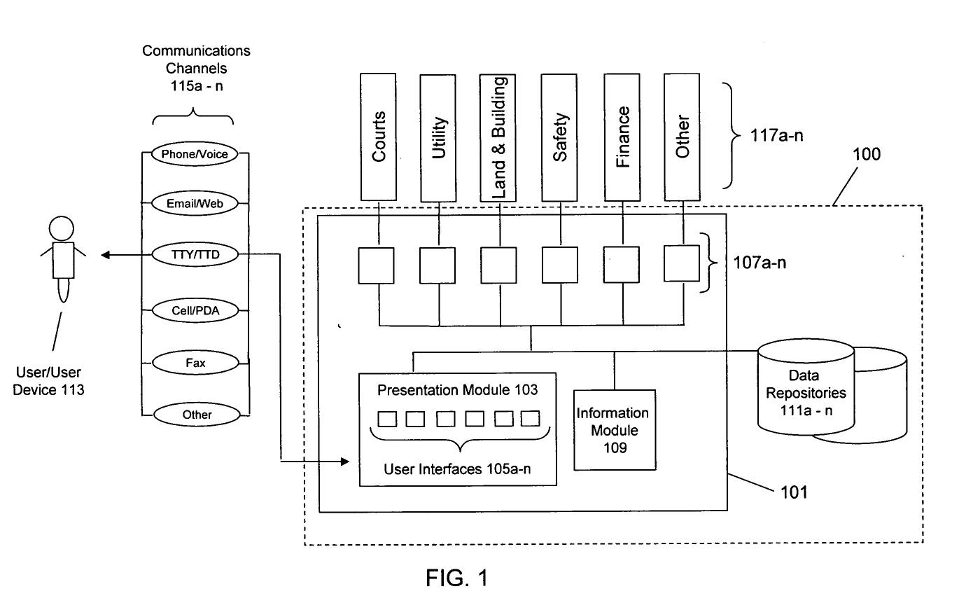

FIG. 1 illustrates a multi-channel communications system 100 according to an embodiment of the invention. In one embodiment, multi-channel communications system 100 may include a common communication platform 101, a presentation module 103, one or more interfaces 105a-n, one or more communication modules 107a-n, an information module 109, one or more data repositories 111a-n, and/or other modules or elements.

In one embodiment, common communication platform 101 may include common infrastructure enabling inbound and outbound communication between one or more users and one or more government entities over one or more communication channels 115a-n. The common infrastructure may include, for example, one or more web servers, one or more email servers, one or more call servers, one or more personal computers or other computers, one or more computer networks, and/or one or more computer applications enabling the inbound and outbound communication. Common communication platform 100 may comprise, host, or support the various modules and/or elements of multi-channel communications system 100 described herein (or other modules or elements).

In one embodiment, multi-channel communications system 100 may include a presentation module 103 that enables one or more user interfaces 105a-n. One or more user interfaces 105a-n may include one or more websites, graphical user interfaces, telephone or voice interfaces, mobile communications interfaces, teletypewriter interfaces, facsimile interfaces, or other interfaces or interaction points that may be accessed by one or more users via one or more user devices 113 over one or more communication channels 115a-n.

One or more communication channels 115a-n may include, for example, telephone or other voice communications, e-mail or web-based communications, special needs communications (e.g., teletypewriter [TTY], telecommunications device for the deaf [TDD], multi-lingual communications, or other special needs communications), cellular or wireless communications, facsimile communications, or other communications channels. One or more user devices 113 may include personal computers, servers, laptop computers, telephones, cell phones, TTY devices, TDD devices, personal digital assistants (PDA's), pagers, facsimile machines, or other communication devices. User devices 113 may enable presentation of data to users and/or allow users to transmit data to multi-channel communications system 100 or one or more entities 117a-n via multi-channel communications system 100. A user may include a person, a group of people, a household, a business, a not-for-profit organization, a quasi-governmental organization, a social organization, an educational organization, a religious organization, or other organization.

In one embodiment, presentation module 103 may utilize web-based or Internet technology, TTY support, telephonic or voice response communications, or any presentation technology necessary for visual or auditory presentation or reception of data between interacting parties at one or more user interfaces 105a-n over one or more of communication channels 115a-n. Presentation module 103 may utilize or interact with one or more communication modules 107a-n to enable presentation of data over communications channels 115a-n.

One or more communication modules 107a-n may be included in or supported by communication platform 101. Communication modules 107a-n may provide dynamic data translation and adapter technology, enabling data exchange between data sources (e.g., users, entities, multi-channel communications system 100, or other data sources), each of which may utilize different data formats. For example, a communication module 107 may “read the web” to convert text information on a web-page of an entity into data to be stored and/or used by multi-channel communications system 100. This converted data may then be sent to one or more user devices 113 over one or more communication channels 115a-n. However, this information may require further conversion into a format suitable for particular communication channels 115a-n and/or one or more user devices 113 (e.g., textual data may require conversion for transmission to a voice-enabled user device). In one embodiment, one or more communication modules 107a-n may perform this further conversion.

An exemplary illustration of the data conversion and transfer capabilities of communication modules 107a-n may include an embodiment wherein a user may view school closing information (government function) on a web page (user interface 105) supported by multi-channel communications system 100 over the Internet (communication channel 115). In the same or similar embodiment, the user may listen to the same school closing information over the telephone (communications channel 115) by calling a telephone number (user interface 105) supported by multi-channel communications system, 100. In this example, communication modules 107a-n may enable school closing information stored on a central data repository 111 of multi-channel communications system 100 to be accessed by or transmitted to the user in any number of data formats utilized by one or more communication channels 115a-n. This transmission may be initiated by the user (e.g., the user logs onto the Internet or calls a telephone number) or by multi-channel communications system 100 (e.g., the user receives an e-mail or a telephone call containing school closing information).

In some embodiments, communication modules 107a-n may be able to receive and/or send information (of numerous data formats) in any number of languages (e.g., Spanish, English, or other languages), and may be able to translate or convert this information to a language desired by a specific user or entity, thus enabling multi-lingual communications.

Communication modules 107a-n may enable information postings for both inbound and outbound communications to and from both user devices 113 and/or entities 117a-n. Such information postings may then be automatically relayed through the one or more communication channels 115a-n. Communication modules 107a-n may distinguish the type of user device requesting or receiving services and may provide E-mail broadcast, Call-Out broadcast, Fax Broadcast, TTY broadcast, and other readily available messaging accessories for customized configurations.

In one embodiment, individual communication modules 107 may exist for individual participating government entities (as illustrated in FIG. 1). In other embodiments, one or more communication modules 107a-n may, in total, serve to enable the functions of the invention for a group of, or all, participating entities.

In some embodiments, communication modules 107a-n may facilitate the transfer of data between one or more users and one or more entities 117a-n over one or more communications channels 115a-n at one or more user interfaces 105a-n. This transfer of data may be user initiated, entity initiated, initiated by multi-channel communications system, or initiated by another party. This transfer of data may serve to provide information from one or more entities 117a-n and information from users that enable the performance of one or more government functions via multi-channel communications system 100.

In one embodiment, presentation module 103 may interact with a broadcast module (not otherwise illustrated in FIG. 1.) to enable dissemination of information with minimal administrative effort. The broadcast module may work with one or more communication modules 107a-n and may rely on dynamic data translation and adapter technology to exchange data from one or more types of data sources for the purpose of interacting with user devices 113 over the one or more communications channels 115a-n. An example of this interaction may include providing alerts to one or more users.

In one embodiment, the invention's ability to act as a hub may enable the use of communication modules 107a-n and/or applications built on these modules as “spokes” that reach out to the databases and/or systems of entities 117a-n, so as to provide or fetch any information not already residing a central data repository 111.

In one embodiment, multi-channel communications system 100 may include an information module 109. Information module 109 may be included in or supported by communications platform 101. In one embodiment, information module 109 may interact with, receive information from, and/or send information to one or more entities 117a-n. One or more entities 117a-n may include a government entity, quasi-government entity, regulatory entities, public service entity, or other entity. One or more entities 117a-n may also include local entities (e.g., town, city), county entities, state entities, federal or national entities, international entities, or other entities. Examples of entities 117a-n may include court systems, safety entities (e.g., police entities, firefighting entities, or other entities), utilities (e.g., water, sewer, electric, gas, trash, telephone, or other entities), land and building entities (e.g., zoning, building safety, health inspector, or other entities), financial entities (e.g., tax authority, comptroller, or other entities), public/social service entities (e.g., welfare, social services, or other entities), parks and recreation entities, educational entities (e.g., schools, school districts, school boards, parent teacher associations, or other entities), or other entities.

In one embodiment, information module 109 may integrate with existing infrastructure of entities 117a-n such as, for example, entity systems, leading edge technologies used on the entity systems (e.g., Customer Relationship Management (CRM) systems, 311 services, Geographic Information System (GIS) modules, content management tools, or other technologies), and/or other elements of entities 117a-n. Entity systems may include any systems of a participating entity, such as, for example, existing entity databases, computers, computer systems, computer networks, or other systems, that provide data to and receive data from multi-channel communications system 100 (or users via multi-channel communications system 100).

In one embodiment, information module 109 may send and receive information to and from one or more entities 117a-n. The information sent to and/or received by information module 109 may include information enabling governmental, quasi-governmental, or other functions to be performed using multi-channel communications system 100. Examples of governmental, quasi-governmental, or other functions may include providing information regarding a participating entity to users (e.g., frequently asked questions or other information), providing notices and/or alerts to users (e.g., license renewal notice, payment due notice, school closing alert, road closing alert, weather alerts, extreme weather alerts, or other notices or alerts), enabling payment of debts owed by user to an entity (e.g., bills, fines, license fees, or other debts or fees), enabling entities to receive requests from users (e.g., license applications/renewals, requests for specific information, requests for documents, or other requests), scheduling services (e.g., user scheduling building inspection, user scheduling appointment, or other scheduling), or other functions. The above list of governmental or quasi-governmental functions is not exhaustive; other functions may exist.

In one embodiment, information module 109 may enable inbound and outbound communication between one or more data repositories 111a-n and the entity systems (automated or manned systems) of entities 117a-n. Communication modules 107a-n may translate data, as necessary, and/or may otherwise facilitate the interaction between entity systems of one or more entities 117a-n and information module 109. As different entities 109 may have different types of computer/information systems, one or more communication modules 107a-n may be utilized to perform any conversions and or adaptations to facilitate fluid information transfer between various entities 117a-n and multi-channel communications system 100.

In one embodiment, information module 109 may also enable inbound and outbound communication between multi-channel communications system 100 and users 113 via communication channels 115a-n. Because communication channels 115a-n may utilize different data formats, information module 109 may utilize communication modules 107a-n for data translation as necessary for this communication. The information transmitted via information module 109 may carry with it process-based functions such as, for example, links to voice response technologies, teletypewriter (TTY) support, faxed documents, online material, customer requests for service and targeted transfers to live staff or separate services. These process based functions may be utilized by communication modules 107a-n to enable transmission and/or presentation of the different data formats utilized by communication channels 115a-n.

In one embodiment, multi-channel communications system 100 may include one or more data repositories 111a-n. Data repositories 111a-n may include one or more databases or other data storage devices. Data repositories 111a-n may store data received from one or more entities 117a-n, including data enabling or related governmental, quasi-governmental, or other functions that are performed using multi-channel communications system 100. For instance, in one embodiment, data repositories 111a-n may feed general consumer information and documentation to automated and manned terminals through multiple inbound and outbound communication channels. In one embodiment, data repositories 111a-n may be part of or utilize information module 109 to receive, store, or transmit data from one or more entities 117a--n.

One aspect of the invention may allow for standardization and/or rapid update and synchronization of information regarding participating entities 117a-n that is available to users of the multi-channel communications system. Information module 109 may provide participating entities 117a-n with numerous templates that help participating entities develop answers to the most common questions posed by users. In one embodiment, these templates may form a portion of information module 109. In one embodiment, information derived from these templates (or stored as entity-completed templates) may form part of the information that information module 109 retrieves and stores in data repositories 111a-n. The information derived from the templates (or stored as entity-completed templates) may be utilized in any communication channel or service environment (phone, TTY, fax, web, email, PDA, or other communication channel or service environment). These templates (blank versions and/or entity-completed templates) may be maintained in data repositories 111a-n and may be updated as necessary.

As performance of governmental, quasi-governmental, or other functions may include an exchange of information between users and entities 117a-n, data repositories 111a-n may also store data received from users or user devices 113, that is related to one or more government functions (e.g., user-specific data).

In one embodiment, information module 109 may include a search engine that enables various search functions to access data repositories 111a-n, such that a user and/or an entity may perform searches of information stored within data repositories 111a-n (assuming a user and or entity has access rights to the information searched).

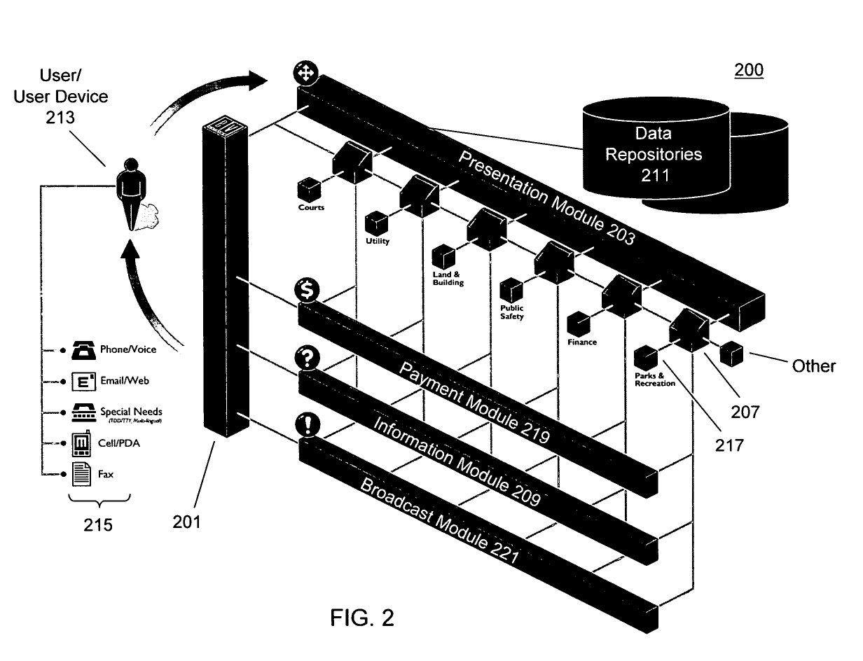

Multi-channel communications system 100 is an exemplary system configuration. Other configurations may exist. FIG. 2 is an exemplary illustration of a multi-channel communications system 200 according to another embodiment of the invention. Multi-channel communications system 200 may include a common communication platform 201, a presentation module 203, one or more communication modules 207, an information module 209, one or more data repositories 211, a payment module 219, a broadcast module 221, a service module (not otherwise illustrated in FIG. 2), and/or other modules or elements. Multi-channel communications system 200 may also provide one or more user interfaces (not otherwise illustrated in FIG. 2). Multi-channel communications system 200 may enable communication and/or interaction between one or more users or user devices 213 and one or more entities 217, over one or more communication channels 215 at the common access point.

In one embodiment, multi-channel communications system 200 may include a payment module 219. Payment module 219 may enable secure and fluid electronic payment and/or electronic transfer of funds between users, financial institutions, and government entities. Electronic payment may be used whenever multi-channel communications system 200 needs to collect funds from a user on behalf of an entity or the operator of multi-channel communications system 200. Such situations may include, for example, payment for license renewal, utility bill payment, court fee payment, payment for inspection or approval services, payment for repair or installation services, payment for services provided by multi-channel communications system 200, or other electronic payments.

In one embodiment, payment module 219 and/or multi-channel communications system 200 may enable a user to pay the total of all amounts owed to entities participating with multi-channel communications system 200. In one embodiment, payment module 219 and/or multi-channel communications system 200 may enable a user to pay an amount owed to individual entities separately. A user desiring to pay electronically may first choose a payment type, which may include credit card, eCheck, PayPal or other form of electronic payment. The user may then enter payment information, for example: credit card number, credit card expiration date, amount of payment, or other information. Multi-channel communications system 200 may then ask the user to confirm the user's payment information. If the user indicates that payment information is incorrect, the user may be directed to an interface that controls electronic payment and asked to re-enter the user's payment information. If the user finds that payment information is correct, the user may then submit payment, whereupon payment module 219 may communicate via a secure connection with an accredited third party payment processor. In some embodiments, security for electronic payment and/or for other electronic communication aspects of the invention may utilize secure socket layer (SSL) encryption technology. In other embodiments, other security technology may be used.

Once the payment processor receives the user's payment information, it may begin an exchange with the relevant financial institutions (user's bank, payee/government entity's bank, or other financial institution). If authorization problems occur at this point, the information may be sent back to the user via multi-channel communications system 200. Following approval, funds may be debited from the user's bank account and received by the payment processor. Next, the processor may deposit all funds into the payee's (entity receiving payment) bank account. When payment is completed, the payment processor may notify multi-channel communications system 200, which in turn may provide the user with a printable receipt or other confirmation of payment.

In one embodiment, multi-channel communications system 200 may include a broadcast module 221. Broadcast module 221 may enable information dissemination and may work with information module 209, one or more communication modules 207, and/or other modules or elements of multi-channel communications system 200 to accelerate information administration and broadcast alerts to users or user devices 213.

In one embodiment, multi-channel communications system 200 may include a service module (not otherwise illustrated). In some embodiments, the service module may be included in or supported by information module 209 or the other modules or elements of multi-channel communication system 200. As previously mentioned, government services provided at users' request may pose difficulties for traditional message management technologies. Typically, general user/citizen inquiries are directed to specific service request portals of individual government entities. Often times, government entity availability is limited to traditional business hours, and there are limited means (usually, telephone calls, traditional mail) for providing information to users such as, for example, notifying users of the status of their service requests or for providing other information to users.

The service module of multi-channel communications system 200 may solve these problems. In one embodiment, the service module may sort through incoming user communications to remove or re-route general user inquiries, and properly log or otherwise handle specific service requests or other requests. The service module may operate on the multi-channel communications system twenty-four hours a day, seven days a week, and thus, may allow service requests to be initiated at any time. Furthermore, service module may associate a tracking identifier (e.g., a tracking number) with individual user requests and provide that tracking identifier to the user, thus, enabling users to access status information regarding particular requests via the multi-channel communications system.

Other features, functions, or operations of the invention, including any features, functions, or operations described herein may be enabled by other modules included in multi-channel communications systems 100, 200 or other multi-channel communications systems according to the invention. In some embodiments, one or more of the modules included in multi-channel communications systems 100, 200 or other multi-channel communications systems of the invention may be combined. For some purposes, not all modules may be necessary.

Those having skill in the art will appreciate that the invention described herein may work with various system configurations. Accordingly, more or less of the aforementioned system components may be used and/or combined in various embodiments. In some embodiments, as would be appreciated, the functionalities described herein may be implemented in various combinations of hardware and/or firmware, in addition to, or instead of, software.

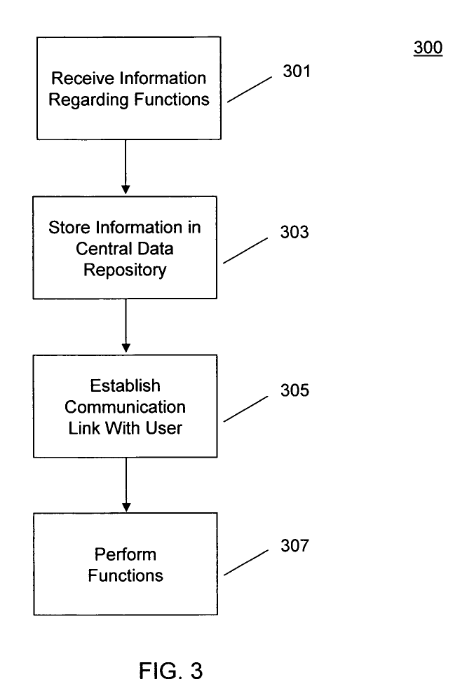

In one embodiment, the invention enables a computer-implemented method for providing one or more governmental, quasi-governmental, or other functions of one or more government entities to one or more users via a multi-channel communications system (such as, for example multi-channel communications system 100 of FIG. 1). FIG. 3 is an exemplary illustration of a process 300 for performing this method. Process 300 may utilize one or more user interfaces (such as, for example, user interfaces 105a-n of FIG. 1) that may be included in or supported by a presentation module (such as, for example presentation module 101 of FIG. 1 or presentation module 201 of FIG. 2). Process 300 may utilize communication (and or communication links) between the one or more government entities and the one or more users over one or more communication channels that is facilitated by the multi-channel communications system.

In an operation 301, the multi-channel communications system may receive information regarding the one or more functions to be performed from the one or more entities. For example, the multi-channel communications system may receive information from a police authority regarding a road closing. In one embodiment, an information module (e.g., information module 109 of FIG. 1) and/or one or more communication modules (e.g., communications modules 107a-n of FIG. 1) may enable the receipt of this information. In an operation 303, the information regarding the one or more functions may be stored in a data repository (e.g., data repositories 111a-n of FIG. 1).

In an operation 305, a communication link between the multi-channel communications system and a user may be established over one or more communication channels. This communication link may be initiated by the user, by the multi-channel communications system, by one of the one or more entities, or by another party. In some embodiments, the communication link may be established according to user-specific data associated with a user. For example, if multi-channel communications system were providing the service of an information broadcast of road closing information to a user, the system may utilize the user's specified alert parameters for traffic broadcasts to contact the user. These parameters may be stored in a data repository as part of a set of user-specific data. In another example, if the user desired to renew his or her fishing license with a government entity via the multi-channel communications system, the user may log onto a system website. By virtue of logging onto the system website, the user has provided user-specific data regarding the type of communication channel by which the licensing function is to be provided.

In some embodiments, the one or more communication modules may enable the establishment of the communication link. In some embodiments, a communication link may include a connection enabling data exchange over one or more communication channels. For example, a communication link may include a telephone connection, an Internet or computer network connection, a wireless connection, or other connection. In some embodiments, the communication link may include a single continuous data exchange connection. In other embodiments, the communication link may include a plurality of separate data exchange connections.

Once the communication link is established, the user may access the information regarding the one or more functions at one or more user interfaces using one or more user devices. In the above example of a road closing broadcast, the multi-channel communications system may present the road closing information provided by the police authority on one or more user interfaces accessible by the user. The user may then view, listen to, or otherwise access information detailing the road closing via the one or more user interfaces. The type/manner of access to the information may depend on the communication channel used by the user interfaces.

In an operation 307, the one or more government functions may be performed. One or more government functions may include any of the functions described herein. In some embodiments, user-specific data may be utilized to perform the one or more government functions. For example, if the government function was a road closing information alert, the system may utilize the user's identification, contact, and/or preference data to determine to whom, how, and when to provide the alert. If the government function included a fishing license renewal, the system may utilize the user's stored identification data (user-specific data) to complete part or all of the fishing license application.

One of the advantages of the invention includes that the centralized nature of the multi-channel communications system enables a user to be provided with multiple government functions from a single, centrally-located set of user-specific data. For example, once the user of the fishing license example is finished renewing his or her fishing license, the user may pay his or her water bill, using the same system. The user may not need to re-enter his or her identification, payment, or other information, because this information may be stored in the user's set of user specific data.

Because process 300 may involve the exchange of data with the multi-channel communications system over the one or more communications channels, one or more communication modules or other elements of a multi-channel communications system may be utilized to convert data of different formats and/or to provide the converted data to users, the communications system, and/or the one or more government entities.

In some embodiments, a multi-channel communications systems according to the invention, and some or all of the various elements features, functions, methods, process, and/or operations described herein may be maintained and/or performed by a service provider. In other embodiments, these systems, features, functions, methods, processes, and/or operations may be maintained and/or performed by a participating entity, a group of entities, or other party.

As detailed herein, an inbound/outbound multi-channel communications system may provide a common communication platform by which a user may access a plurality of governmental, quasi-governmental, or other functions. This common communication platform may enable user or entity initiated interaction or communication over one or more communication channels. Exemplary embodiments of this interaction and/or communication between a user and one or more entities that takes place over the internet (communication channel) using a computer (user device) at one or more graphical user interfaces are given below. Other types of communication channels, devices, and/or interfaces may be utilized.

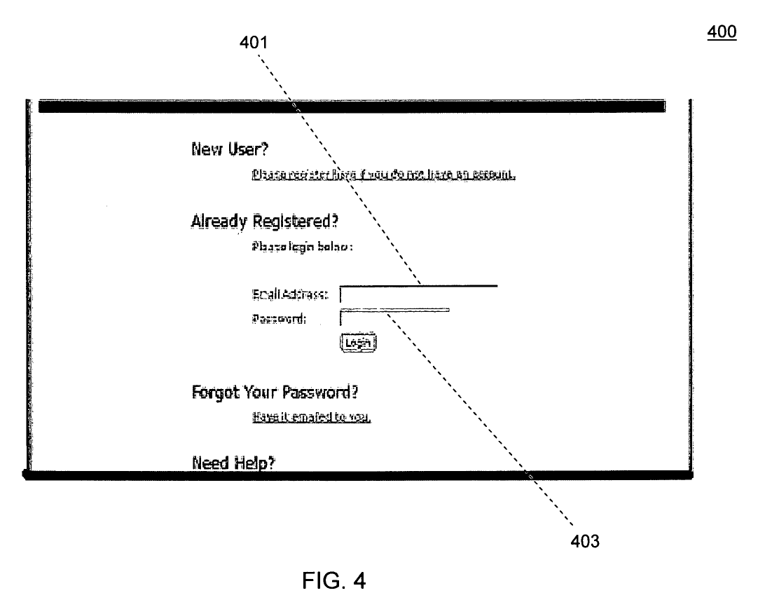

In one embodiment, a user may use a computer to interact with a multi-channel communications system via a website. The website may include a first web interface comprising a login interface, wherein the user is prompted to enter information particularly identifying an account the user has with the multi-channel communications system. FIG. 4 is an exemplary representation of a login interface 400 according to the invention. Information prompted by login interface 400 may include a user identifier 401 (such as, for example, an email address, screen name, or other user identifier) coupled with a security identifier 403 (such as, for example, a password, a personal identification number, or other security identifier).

If a user does not have an established account with the multi-channel communications system, the user may be directed to a registration interface wherein the user can register an account with the multi-channel communications system. After the user has created an account with the multi-channel communications system, the user may be directed back to login interface 400.

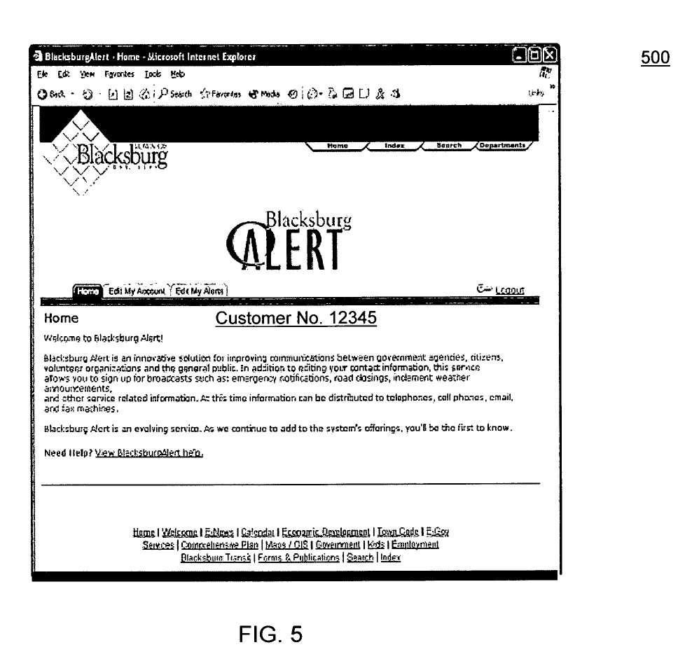

If the user enters valid account login information on login interface 400 and submits the information, the login information may be processed by the multi-channel communications system and the user may be presented with an “account home” interface. An account home interface may display/present a portion of the user's account information and/or may allow the user to navigate to other features of the multi-channel communications system and interact with one or more entities. FIG. 5 is an exemplary illustration of an account home interface 500 according to an embodiment of the invention.

One of skill in the art will recognize that the embodiments of FIGS. 4 and 5 (or other figures provided herein) are exemplary only and are not intended to limit the invention. In other embodiments, a user may interact with the multi-channel communications system over various communications channels using other user devices and provide login information through varying user interfaces. A user may then be able to access aspects of participating entities (including one or more functions) through such interfaces.

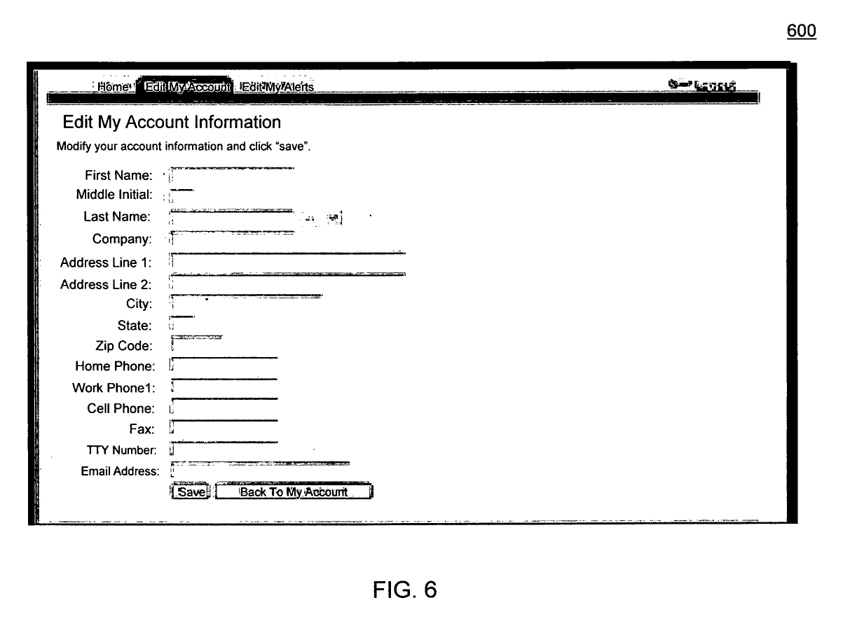

In one embodiment, an account home interface (such as, for example, account home interface 500 of FIG. 5) may allow a user to access the user's account information via an account information interface. User account information may include the user's personal information, such as name and address. User account information may also include an account number, the user's login name, password, the identity of the user's selected user devices (including all relevant information necessary for communication between the multi-channel communications system and the user device, such as a user's IP address, cell phone number, device identification number, or other device information), and other information. User account information and/or other information regarding the user may be considered user-specific data and may be stored in a data repository (e.g., data repositories 111a-n of FIG. 1). The account information interface may allow the user to view/hear and/or edit the user's account information. For example, if the user changes his or her phone number, the user can update this information on an account information editing interface. FIG. 6 illustrates an exemplary embodiment of a web-based account information editing interface 600. Other embodiments (interfaces for voice, TTY, PDA, or other communication channels) may be used.

In some embodiments, an account home interface (such as, for example, account home interface 500 of FIG. 5) may also allow a user to access the user's alert or other communication protocols. The user's alert or other communication protocols may include a set of alert parameters (which may or may not be selected by the user) that dictate the date, time, device, and level of interaction the user has with various entities via the communications device. The alert parameters may be considered user-specific data and may be utilized by a broadcast module (such as, for example, broadcast module 221 of FIG. 2) or other module or element of the multi-channel communications system to provide alerts or other information to the user.

In some embodiments, the user may select the alert parameters which the broadcast module utilizes to provide alerts. For example, the user may select an alert option that sends the user a voice message on her cell phone regarding the traffic on local roads. The user may select the days and times she wants this message sent to her cell phone. The communication protocol interface may allow the user to view and/or edit the user's alert protocol. For example, the user may change the days and times or the device to which alerts are sent (e.g., from cell phone voice message to email alert).

In other embodiments, the broadcast module may utilize user characteristics or other information not necessarily entered or selected by the user to generate user-specific data, to set the alert parameters, and/or to provide alerts to the user. For example, the user may not have selected to be telephoned in the event of a tornado. However, the multi-channel communications system may recognize that the user lives in an area where a tornado warning is located, and may utilize this information to provide the user with an alert (via telephone or other communication channel) regarding the tornado.

In one embodiment, an account home interface (such as, for example account home interface 500 of FIG. 5) may also enable the user to obtain information from, provide information to, or otherwise interact with functions of one or more entities. In an exemplary embodiment, interaction with an entity may include various types of license renewal. For example, a user may use the multi-channel communications system to renew his or her taxi license. The user may link from an account home interface to a license renewal interface. The license renewal interface may be specific to the government entity controlling taxi licenses, or may be a general license renewal interface, which may allow the user to choose taxi license renewal from a list of possible choices.

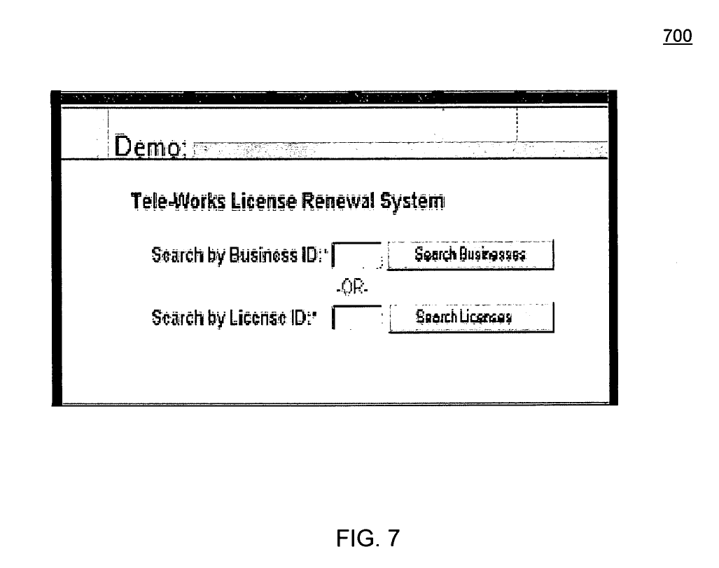

FIG. 7 illustrates an exemplary web-based license renewal interface 700 according to an embodiment of the invention. At license renewal interface 700, the user may be prompted to enter information identifying the particular license to be renewed. This information may include a business ID number, which identifies the company or person holding the particular taxi license (which may return a number of licenses held by the company or person, from which the user may then choose), or may include the license ID number identifying the particular license to be renewed. In some embodiments, by virtue of logging onto the system (e.g., as in FIG. 4), the user's license information may be automatically displayed to the user. This feature may be enabled because the numerous participating government entities may have access to part or all of a common set or user-specific data for the user.

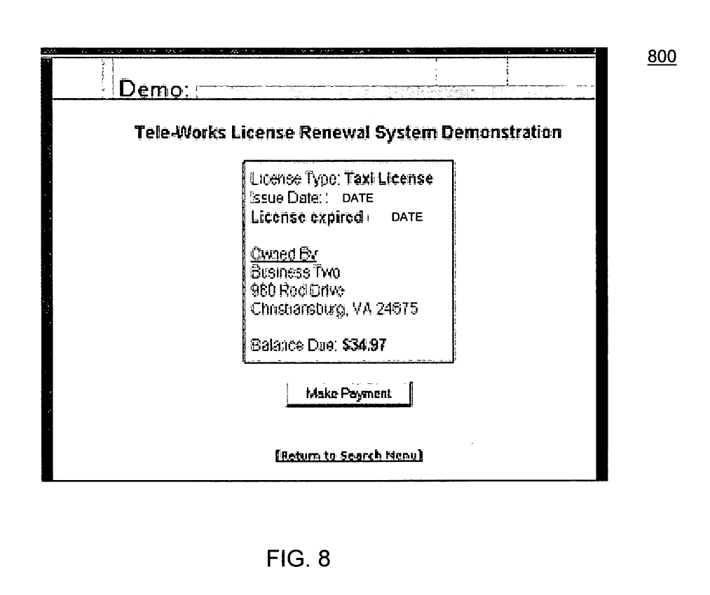

Once the particular taxi license is identified, information pertaining to the license may be displayed. FIG. 8 is an exemplary illustration of a web-based license information interface 800 according to an embodiment of the invention. Other embodiments (e.g., interfaces for voice, TTY, PDA, or other communication channels) may be used. The information provided by license information interface 800 may include the type of license, the license ID number, the business ID number, the expiration date, the owner of the license, and the balance due on renewal of the license. This information may have originally been stored on an entity system. The multi-channel communications system may have utilized an information module (e.g., information module 109 of FIG. 1) and/or a communication module (e.g., communication module 107 of FIG. 1) to retrieve this license information regarding the user from the entity system. The multi-channel communications system may then store the user's license information in a data repository (e.g., data repositories 111a-n of FIG. 1). The multi-channel communications system may then utilize the information module, communication module, and/or other modules to provide the license information to the user over the web (communication channel) at license information interface 800 (user interface).

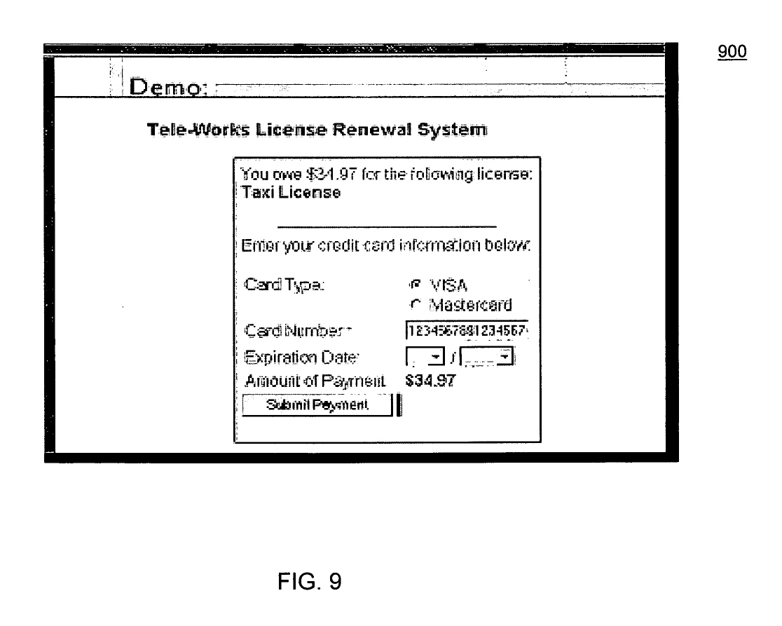

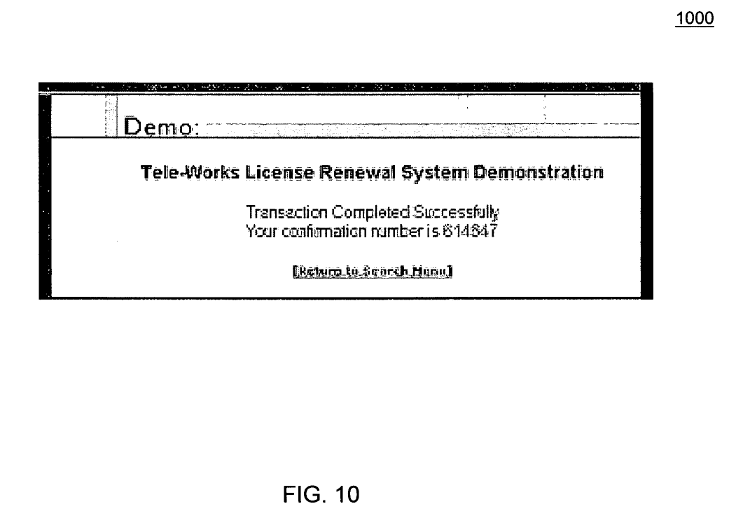

In one embodiment, the user may choose to pay the balance due and renew the license. Upon choosing the payment option, the user may be directed to a payment interface that controls electronic payment enabled by a payment module (such as, for example payment module 219 of FIG. 2). FIG. 9 is an exemplary illustration of a web-based payment interface 900 according to an embodiment of the invention. FIG. 10 is an illustration of a web-based embodiment of a payment confirmation interface 1000 according to an embodiment of the invention. Other embodiments (e.g., voice, TTY, PDA, or other communication channels) may be used. Payment confirmation interface 1000 and/or other confirmation interfaces may be enabled by the payment module and may notify the user that payment or other function/action was successful.

In one embodiment, interaction with a government entity may involve other government functions. For example, a particular government entity may offer building inspection services. A user may use the multi-channel communications system to obtain information regarding building inspection, check the status of a building or group of buildings being inspected, schedule a building inspection, or pay an entity for building inspection services.

In an exemplary embodiment involving a building inspection function, a user may link from an account home interface (such as account home interface 500 of FIG. 5) to a building inspection interface. Once presented with the building inspection interface, the user may enter identifying information regarding the particular building or buildings to be inspected and/or the particular permit sought. This identifying information may be considered user-specific data and may include a permit ID number, building ID number or other information that indicates the specific target or targets of the building inspection. In embodiments involving other services provided by participating government entities, information exchanged between a user and a participating government entity may vary with the type of service provided.

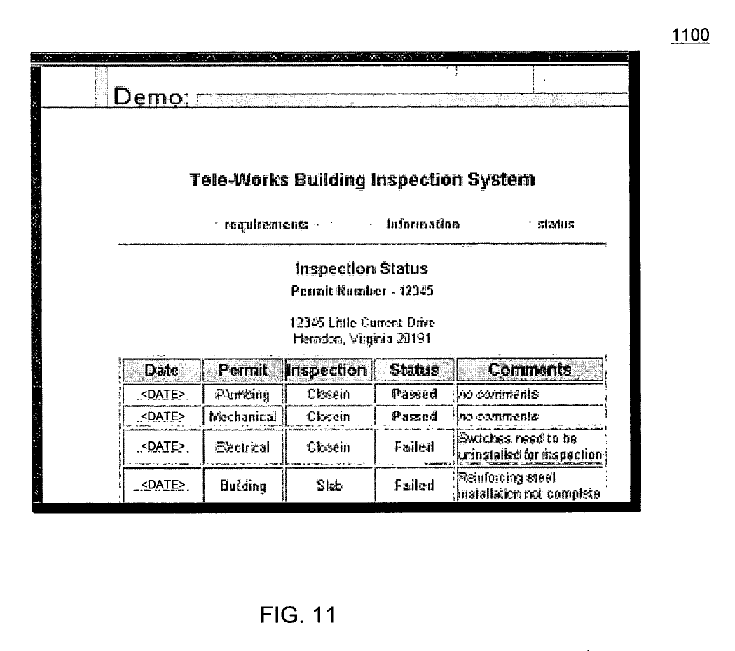

In the building inspection example, once a user has provided identifying information, the multi-channel communications system may direct the user to an interface providing information regarding the permit or building under inspection. In some embodiments, a user who is logged onto the system may be automatically presented with his or her building inspection information. The interface providing information may include information from a data repository (e.g., data repositories 111a-n of FIG. 1) that has been retrieved from a building inspection entity via an information module (e.g., information module 109 of FIG. 1) and formatted for an internet communication channel by a communication module (e.g., communication module 107 of FIG. 1). FIG. 11 is an exemplary illustration of an interface 1100 according to an embodiment of the invention that provides building inspection information. Other embodiments (e.g., interfaces for voice, TTY, PDA, or other communication channels) may be used. The building inspection information may include the permit ID number, building ID number, lot number, the owner or entity seeking inspection or permit, the various types or components of inspection (plumbing, electrical, structural, or other component), the status of any type or component of inspection (passed, failed, pending, or other status), comments regarding any type or component of inspection, or any other pertinent information.

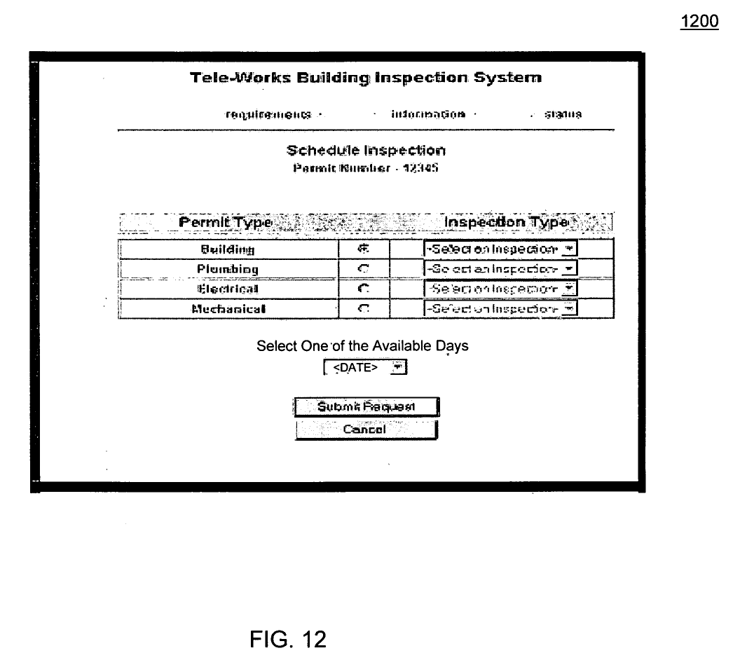

According to another exemplary embodiment, a government function enabled by the multi-channel communications system may include a user scheduling a service provided by an entity. FIG. 12 is an exemplary illustration of a service schedule interface 1200 according to an embodiment of the invention. Other embodiments (e.g., interfaces for voice, TTY, PDA, or other communication channels) may be used. In the exemplary building inspection service schedule interface of FIG. 12, a user may identify the permit or building to be inspected, select the type of inspection to be completed, and select a date and time for the inspection. In embodiments involving other services, the information transmitted/exchanged by a user and a participating government entity may vary. For service selection enabled by the multi-channel communications system, the user may also pay electronically for scheduled services via the multi-channel communications system. Electronic payment may be similar to the payment process described above and may be enabled by a payment module. In some embodiments, because numerous government entities may have access to part or all of a set of user-specific data, a user logged onto the system may have user-specific payment information presented to him or her automatically, thus enabling payment to be commenced by simple authorization (e.g., click a “submit payment” button). This may alleviate the need for the user to enter his or her payment information each time a payment is to be made.

In another embodiment, interaction with entities enabled by the multi-channel communications system may include payment of various types of debts owed to government entities. For example, a government entity or quasi-government entity such as the provider of water or sewage utilities may allow users to pay their water or sewage bill via the multi-channel communications system.

In one embodiment, a user may link from an account home interface (such as account home interface 500 of FIG. 5) to a bill payment interface. This bill payment interface may be specific to utilities operated by certain entities or may be a general payment interface that may list the various debts and/or payments that may be made via the multi-channel communications system. Once the user is directed to the bill payment interface, the user may select the bill he or she wants to pay. In some embodiments, the user may pay a lump sum amount that represents the total of debt/payments owed to entities participating in the multi-channel communications system. As the multi-channel communications system provides a central communications “hub,” with participating entities acting as spokes attached to the central hub, the lump sum amount may be distributed to the participating entities via the modules and elements comprising these spokes (e.g., communications modules, entity systems, or other elements).

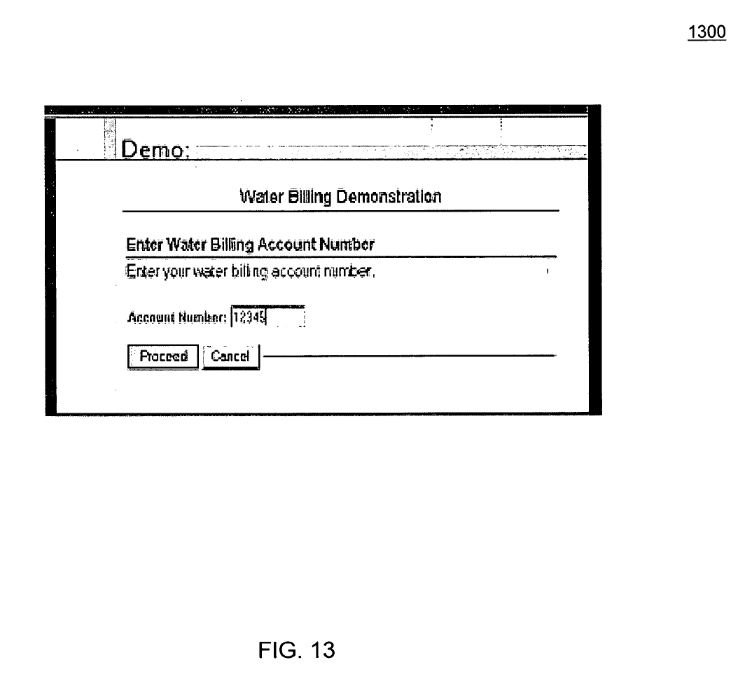

When paying an individual bill, the user may be asked to provide identifying information regarding the particular account at issue. FIG. 13 is an exemplary illustration of a web-based bill payment interface 1200 for paying a water bill. Other embodiments (e.g., interfaces for voice, TTY, PDA, or other communication channels) may be used. In this example, information prompted by interface 1300 may include an account ID number, a business name, or other identifying information. In some embodiments, a user logged onto the system may have this information automatically presented to him or her.

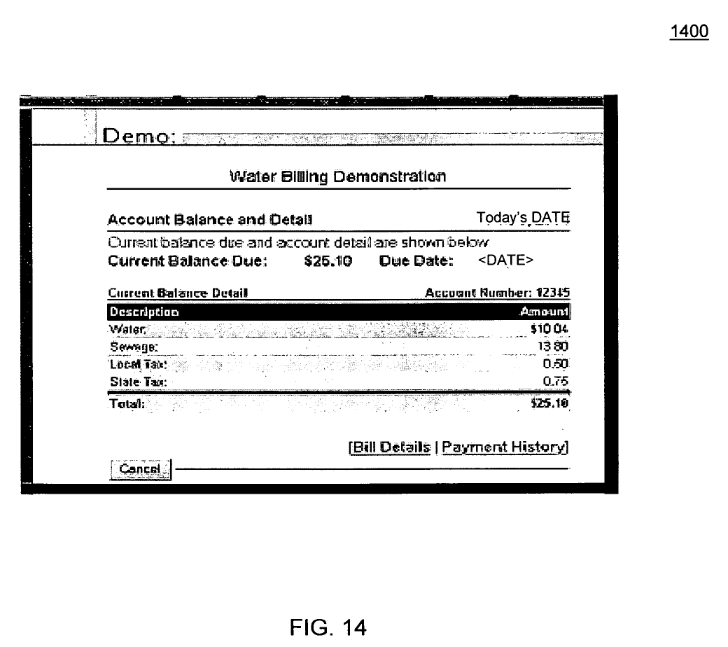

In some embodiments, after a user submits the identifying information, the user may be presented with information regarding the details of the user's account. This account information may include an account ID number, a holder of the account, detailed charges to the account, applicable taxes, a balance due and/or other information. FIG. 14 is an exemplary illustration of a web-based interface 1400 that displays this account information according to an embodiment of the invention. Other embodiments (e.g., interfaces for voice, TTY, PDA, or other communication channels) may be used. In one embodiment, the user may then electronically pay the bill as enabled by the payment module (such as, for example payment module 219 of FIG. 2). In embodiments involving other debts, information exchanged by a user and participating entities may vary.

In one embodiment, a user may receive information from one or more entities via the multi-channel communications system. In one embodiment, a broadcast module (such as, for example, broadcast module 221 of FIG. 2) may enable the one or more entities to provide this information to users. Information from one or more entities and/or one or more entity systems may be retrieved by an information module (e.g., information module 209 of FIG. 2), stored in a central data repository (e.g., central data repository 211 of FIG. 2) and transmitted by the multi-channel communications system to a user over one or more communication channels (e.g., communication channels 215 of FIG. 2) via one or more user devices. In one embodiment, the multi-channel communications system may utilize the information module and/or the communication modules for receipt and/or any necessary conversion of data from a format utilized by the entities or entity systems to a format used by the central data repository. In one embodiment, the multi-channel communications system may utilize the information module and/or the communication modules to transmit and/or convert any data from the format used for storage in the central data repository to the format used by the communication channels and the user devices.

In some embodiments, a user may select what type of information is sent to the user, the time and interval that each type of information is sent to the user, and to what user device the information is sent. These selections may be stored as the user's alert parameters. These alert parameters may be considered user-specific data and may be utilized by the broadcast module to determine, who receives alerts, when they are received, where they are received (e.g., home, office, or other location), how they are received (e.g., via text, or voice; via email or text page), and when they are received (e.g., only when an event occurs or at certain intervals).

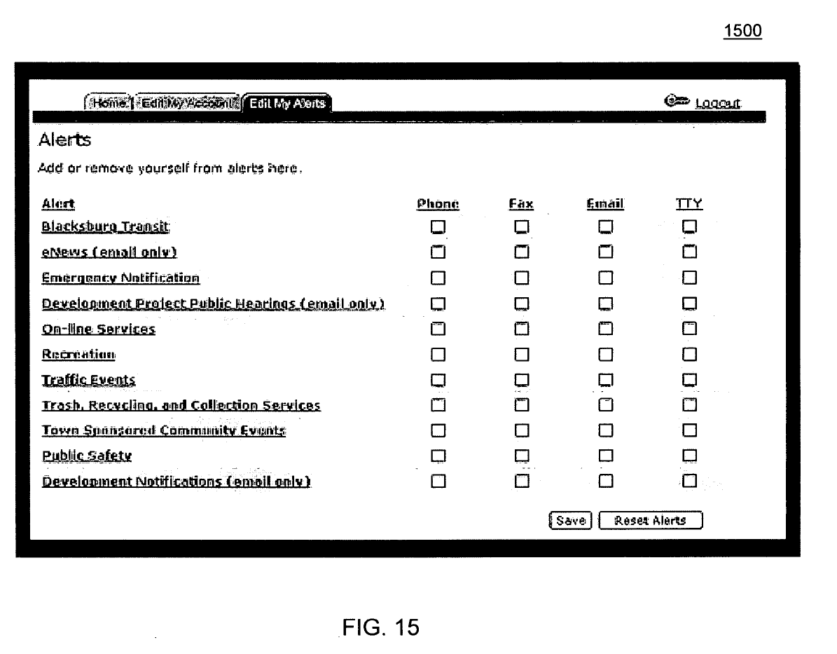

FIG. 15 is an exemplary illustration of an alert parameter selection interface 1500 according to an embodiment of the invention, wherein a user may select parameters to be used by the broadcast module for providing alerts or other information to the user. Other embodiments (e.g., interfaces for voice, TTY, PDA, or other communication channels) may be used. In one embodiment, a user may link from an account home interface (such as, for example, account home interface 500 of FIG. 5) to an alert parameter selection interface.

From the alert parameter selection interface the user may actively define/select from various “alerts” that may be provided to the user by various entities participating in the multi-channel communications system. Examples of these alerts may include traffic information, news, community events, emergency information, recreation information, or other information. The user may also choose user devices to which the communication system will provide alerts (by doing so, the user may also be selecting the communication channels over which the alerts will be provided). For example, the user may decide that traffic alerts should be sent to the user's cell phone, while community event information should be sent to the user's personal computer via email. The user may also specify the time and interval that particular alerts are to be sent. For example, the user may specify that traffic alerts are to be sent to the user's cell phone, every half hour from 5:00 p.m. to 7:00 p.m. on weekdays, while community event alerts are to be sent to via email at 5:00 p.m. on Sundays.

In some embodiments, one or more entities may send alerts or information to a user based on alert parameters/user-specific data not actively defined/selected by the user. In some embodiments, these non-user-selected parameters may be based on a user's characteristics (e.g., age, location, user type, past user history, or other information), or other information regarding the user. For example, an entity may send an alert to the user that the user owes one or more entities money, even though the user has not set his or her parameters to select for this alert. In another example, the users past transactions or interactions with the system that relate to local parks may prompt the system to send the user an alert regarding upcoming park-related events.

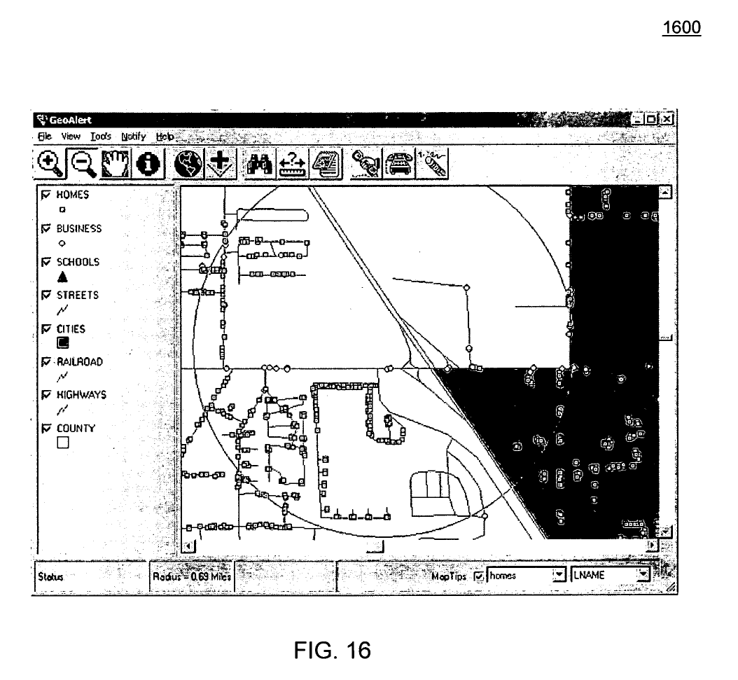

In one embodiment, entities may send information or alerts to users via geographic selection. For example, if an entity involved with public safety desires to send a tornado alert to users in a specific area of a county or state, the entity may do so via the multi-channel communications system. The entity may interface with the multi-channel communications system via a web page or other interface specifically created for that entity's use. In some embodiments, the entity's interface and/or the specifically created web paged may be enabled by an information module (e.g., information module 209 of FIG. 2), the communication modules (e.g., communication modules 207 of FIG. 2), and or other elements of the multi-channel communications system. The entity may login to the multi-channel communications system and may be directed to a geographic selection interface. FIG. 16 is an exemplary illustration of a geographic selection interface 1600 according to an embodiment of the invention. The entity may then select a geographic area to which a tornado alert is to be sent. In one embodiment, the entity may then provide specific information regarding the alert, such as the type of alert (tornado, or other emergency), any instructions that may accompany such alert (take cover, or other instruction), or other information. The broadcast module may then send the alert to one or more user devices of some or all users in the geographic area. For the purposes of some embodiments, a user may include persons or entities not registered with or having an account with the multi-channel communications system or participating entities. For example, a tornado alert may be broadcast to all telephone, pager, TTY, cell phone, or fax numbers in a selected area, instead of only to the numbers of registered users.

In some embodiments, an entity may select a subset of users in a selected geographic area to which to send alerts or information. For instance, if the alert were not a tornado alert sent by a public safety entity, but a school cancellation alert sent by the local school system, the entity (school system) may choose to send the alert only to households (as opposed to businesses or other entities) within the selected geographic area.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented, centralized, inbound/outbound multi-channel communications system that enables communication between one or more entities and one or more users over one or more communication channels, wherein the multi-channel communications system enables the one or more entities to provide one or more functions to the one or more users, the system comprising:
a presentation module that enables one or more user interfaces, wherein the one or more user interfaces can be accessed by the one or more users over the one or more communication channels;
an information module that interacts with the one or more entities, receives data regarding the one or more functions, and provides the data regarding the one or more functions to the one or more user interfaces;
a set of user-specific data regarding at least one of the one or more users for which at least one of the one or more functions is to be provided;
one or more data repositories that receive and store the data regarding the one or more functions and the set of user specific data; and
one or more communication modules that enable the transmission of the data regarding the one or more functions between the one or more entities and the one or more interfaces over the one or more communication channels, wherein the at least one user can access the data regarding the one or more functions via the one or more interfaces.

2. The system of claim 1, wherein the one or more entities include one or more of an international entity, a federal government entity, a state government entity, a county entity, a local government entity, or a quasi-governmental entity.

3. The system of claim 1, wherein the one or more entities include one or more of a judicial entity, a utility, a land and building entity, a public safety entity, a finance entity, an educational entity, or a recreational entity.

4. The system of claim 1, wherein the one or more users include one or more of a person, a group of people, a household, a business, a not-for-profit entity, a quasi-government entity, a religious entity, or a social entity.

5. The system of claim 1, wherein a communication channel includes one or more of telephone communications, teletypewriter communications, telecommunications device for the deaf enabled communications, email communications, web-based communications, wireless telephone communications, text-message communications, personal digital assistant enabled communications, or facsimile communications.

6. The system of claim 1, wherein the one or more functions include one or more governmental or quasi-governmental functions.

7. The system of claim 1, wherein one or more functions include one or more of appointment scheduling services, licensing services, debt payment services, alert services, information services, or status check services.

8. The system of claim 1, further comprising a payment module that enables the one or more users to submit payment of one or more debts owed to the one or more entities.

9. The system of claim 1, further comprising a payment module that enables the one or more users to submit payment of one or more debts owed to the one or more entities, wherein the one or more users can submit a bulk payment to the multi-channel communications system which is subsequently apportioned among the one or more entities according to the one or more debts owed.

10. The system of claim 1, further comprising a broadcast module that enables the one or more entities to broadcast one or more messages to the one or more users via at least one of the one or more communication channels.

11. The system of claim 1, further comprising a broadcast module that enables the one or more entities to broadcast one or more messages to the one or more users via at least one of the one or more communication channels, wherein the one or more messages are broadcast according to a set of alert parameters associated with the set of user-specific data.

12. The system of claim 1, further comprising a broadcast module that enables the one or more entities to broadcast one or more messages to the one or more users via at least one of the one or more communication channels, wherein the one or more messages are broadcast according to a set of alert parameters associated with the set of user specific-data, and wherein the set of alert parameters is actively defined by the user.

13. The system of claim 1, further comprising a broadcast module that enables the one or more entities to broadcast one or more messages to the one or more users via at least one of the one or more communication channels, wherein the one or more messages are broadcast according to a set of alert parameters associated with the set of user specific data, and wherein the set of alert parameters is defined by one or more characteristics of the user.

14. A computer-implemented method for providing one or more functions from one or more entities to one or more users via a centralized, inbound/outbound multi-channel communications system that provides one or more user interfaces enabling communication between the one or more entities and the one or more users over one or more communication channels, the method comprising:
receiving information regarding the one or more functions from the one or more entities;
storing the information regarding the one or more functions in a central data repository;
establishing a communication link with at least one of the one or more users over one of the one or more communication channels, wherein the at least one user may access the information regarding the one or more functions at the one or more user interfaces using a user device, and wherein the communication link is established according to a set of user-specific data associated with the at least one user; and
performing one or more of the one or more functions, wherein the one or more functions are performed at least in part according to the set of user-specific data.

15. The method of claim 14, wherein the communication link is initiated by the at least one user.

16. The method of claim 14, wherein the communication link is initiated by the multi-channel communication system.

17. The method of claim 14, wherein establishing a communication link further comprises receiving user information regarding the one or more functions from the at least one user and storing the user information in the central data repository.

18. The method of claim 14, wherein the one or more entities include one or more of an international entity, a federal government entity, a state government entity, a county entity, a local government entity, or a quasi-governmental entity.

19. The method of claim 14, wherein the one or more entities include one or more of a judicial entity, a utility, a land and building entity, a public safety entity, a finance entity, an educational entity, or a recreational entity.

20. The method of claim 14, wherein the one or more users include one or more of a person, a group of people, a household, a business, a not-for-profit entity, a quasi-government entity, a religious entity, or a social entity.

21. The method of claim 14, wherein a communication channel includes one or more of telephone communications, teletypewriter communications, telecommunications device for the deaf enabled communications, email communications, web-based communications, wireless telephone communications, text-message communications, personal digital assistant enabled communications, or facsimile communications.

22. The method of claim 14, wherein the one or more functions include one or more governmental or quasi-governmental functions.

23. The method of claim 14, wherein one or more functions include one or more of appointment scheduling services, licensing services, debt payment services, alert services, information services, or status check services.

24. The method of claim 14, wherein the one or more functions include the at least one user submitting payment of one or more debts owed to the one or more entities.

25. The method of claim 14, wherein the one or more functions include the at least one user submitting payment of one or more debts owed to the one or more entities, wherein the at least one user can submit a bulk payment to the multi-channel communications system that is subsequently apportioned among the one or more entities according to the one or more debts owed.

26. The method of claim 14, wherein performing one or more functions includes broadcasting one or more messages to the at least one user via at least one of the one or more communication channels.

27. The method of claim 14, wherein performing one or more functions broadcasting one or more messages to the one or more users via at least one of the one or more communication channels, wherein the one or more messages are broadcast according to a set of alert parameters associated with the set of user-specific data.
